(19) United States
(12) Patent Application Publication
(10) Pub. No.: US 2026/0132032 A1
(43) Pub. Date: May 14, 2026

(54) METHOD FOR PREPARING CATALYTIC GRAPHITIZED FEW-LAYER COAL-BASED GRAPHENE

(71) Applicant: Xinjiang University, Urumqi (CN)

(72) Inventors: Xiaomei ZHANG, Urumqi (CN); Daiyong CAO, Urumqi (CN); Hao CHEN, Urumqi (CN); Shuo FENG, Urumqi (CN); Xin LI, Urumqi (CN); Xinyu CHEN, Urumqi (CN); Yeersheng JIANGBAOLATI, Urumqi (CN); Shilong KANG, Urumqi (CN); Yungang ZHAO, Urumqi (CN)

(73) Assignee: Xinjiang University, Urumqi (CN)

(21) Appl. No.: 19/442,817

(22) Filed: Jan. 7, 2026

(51) Int. Cl. C01B 32/184

(52) U.S. Cl. CPC C01B 32/184; C01B 2204/04; C01B 2204/22; C01P 2002/72; C01P 2004/04; C01P 2006/40; C01P 2006/80

(57) ABSTRACT

Disclosed is a method for preparing catalytic graphitized few-layer coal-based graphene, comprising the following steps: crushing coal samples to 200 mesh, then treating with hydrochloric-hydrofluoric acid for deashing, and drying at 25° C. for 12 h to obtain a row coal material; grinding and mixing the raw coal and boric acid and loading the mixture into a graphite crucible; transferring the graphite crucible into a graphitization furnace, evacuating the chamber, introducing protective gas and heat treating, and then cooling naturally to room temperature. The prepared coal-based graphene has fewer layers, high crystallinity and strong conductivity, which is superior to the performance of existing coal-based graphene products. Coal, an abundant resource, is used as raw material, the cost is extremely low, and the use of boric acid as a catalyst is environmentally friendly, non-toxic and easy to obtain.

### TECHNICAL FIELD

The present disclosure relates to the technical field of coal-based carbon materials, in particular, to a method for preparing catalytic graphitized few-layer coal-based graphene.

### BACKGROUND

Coal, as an energy resource with abundant reserves and low cost, holds the key to achieve the goals of “carbon peaking” and “carbon neutrality” through its clean and efficient utilization. Carbon materials such as graphite and graphene are widely used in energy storage applications due to their excellent electrical and thermal conductivity. As an organic mixture primarily composed of carbon, coal serves as an ideal raw material for producing coal-based carbon materials, offering both structural and cost advantages.

Current methods for graphene preparation are mainly divided into three categories: The oxidation-reduction method, chemical vapor deposition, and physical exfoliation. The oxidation-reduction method involves complex procedures and often yields products with numerous defects and suboptimal performance; chemical vapor deposition, on the other hand, is characterized by intricate processes and high production costs; while physical exfoliation is simple and low-cost, it's extremely low output makes it unsuitable for large-scale production. Furthermore, existing technologies for preparing coal-based graphene commonly face challenges such as excessive layer count (>10 layers), low crystallinity, and strong heterogeneity. The frequent use of metal catalysts also introduces issues like high cost and difficult separation, severely hindering the industrial-scale production and application of coal-based graphene.

Therefore, there is an urgent need in the field to develop a technology that is low-cost, easy to operate, scalable, and capable of producing coal-based graphene with few layers and high crystallinity.

### SUMMARY

An objective of this present disclosure is to provide a method for preparing catalytic graphitized few-layer coal-based graphene. Utilizing high-temperature treatment as a fundamental process, this method employs coal as a raw material and inexpensive, environmentally friendly boric acid as a catalyst. After thorough grinding and homogenization, high-temperature treatment is conducted; through high-resolution transmission electron microscopy, X-ray diffraction analysis, and conductivity testing, this method produces few-layer coal-based graphene with excellent structure and high electrical conductivity.

To achieve above purposes, the present disclosure provides a method for preparing catalytic graphitized few-layer coal-based graphene, this method includes following steps:
S1, raw material pretreatment: Crushing coal samples to 200 mesh, then treating with hydrochloric-hydrofluoric acid for deashing, and drying at 25° C. for 12 h to obtain a row coal material;
S2, catalyst mixing: Grinding a raw coal and boric acid thoroughly until uniformly mixed, achieving a particle size of 200 mesh, then loading the mixture into a graphite crucible;
S3, high-temperature graphitization: Transferring the graphite crucible into a medium-frequency induction graphitization furnace, after evacuating a chamber, introducing protective gas, and raising a temperature to a heat treatment temperature, holding, then cooling naturally to room temperature;
S4, product characterization: Using high-resolution transmission electron microscopy, X-ray diffraction, and four-probe conductivity test to characterize morphology, structural characteristics, and conductive characteristics of few-layer coal-based graphene.

In some embodiments, in S1, after the coal samples are deashed, no mineral peak is detected by X-ray diffraction.

In some embodiments, in S2, a purity of boric acid is more than 99.5%, and a mass ratio of raw coal to boric acid is 4:1.

In some embodiments, in S3, a protective atmosphere is argon, an argon flow rate is 3 L/h, a heating rate is 10° C./min, the heat treatment temperature is 3000° C., and a holding time is 3 h.

The present disclosure also provides a catalytic graphitized few-layer coal-based graphene, which is prepared by above preparation methods.

In some embodiments, number of layers of the coal-based graphene is less than 10, a degree of graphitization is more than 80%, a purity is more than 80%, and a electrical conductivity is not less than 60000 S/m.

The advantages and beneficial effects of the above-mentioned method for preparing catalytic graphitized few-layer coal-based graphene are as follows:
1, the coal-based graphene prepared by the present disclosure has fewer layers, high crystallinity, and strong conductivity, outperforming properties of existing coal-based graphene products.
2, the preparation method of the present disclosure uses coal, a resource with abundant reserves, as the raw material, resulting in extremely low cost, boric acid is employed as a catalyst, which is environmentally friendly, non-toxic, and easily accessible. A graphitization process is simple with low equipment requirements, a preparation of few-layer coal-based graphene can be achieved through a process of “coal sample crushing-catalyst mixing-heating-heat preservation-cooling-testing”, enabling large-scale popularization and application.

The following is a further detailed description of technical schemes of the present disclosure through drawings and embodiments.

### BRIEF DESCRIPTION OF THE DRAWINGS

FIG. 1 is an XRD pattern of different catalysts of the present disclosure;

FIG. 2 is a HRTEM image of the catalytic graphitized sample of the present disclosure;

FIG. 3 is a HRTEM image of the 5-layer catalytic graphitized sample of the present disclosure;

FIG. 4 is conductivity characteristic curves of the graphitized sample catalyzed by boric acid and other comparison groups of the present disclosure.

### DETAILED DESCRIPTION OF THE EMBODIMENTS

The following is a further explanation of the technical schemes of the present disclosure through drawings and embodiments.

Unless otherwise defined, the technical terms or scientific terms used in the present disclosure should be understood by people with general skills in the field to which the present disclosure belongs.

The following embodiments are not used to restrict the present disclosure, but only to illustrate the present disclosure. If there is no special explanation for the experimental methods used in the following embodiments, the experimental methods with specific conditions are not specified in the embodiments. Usually, according to the conventional conditions, the materials and reagents used in the following embodiments can be obtained from commercial channels without special explanation.

### Embodiment 1

A method for preparing catalytic graphitized few-layer coal-based graphene includes the following steps:
S1, raw material pretreatment: The coal samples are crushed to 200 mesh, deashed using hydrochloric acid-hydrofluoric acid, and dried at 25° C. for 12 h to obtain raw coal, after deashing, there is no mineral peak detected by X-ray diffraction.
S2, catalyst mixing: According to the mass ratio of coal to boric acid of 4:1, the raw coal and boric acid powder with purity more than 99.50% are fully ground thoroughly, so that the particle size of the mixed raw material is maintained at 200 mesh.
S3, high temperature graphitization: The mixed raw materials is put into the graphite crucible and move into the medium-frequency induction graphitization furnace; after vacuuming, argon is introduced as a protective atmosphere at a flow rate of 3 L/h, the temperature is raised to 3000° C. at a heating rate of 10° C./min, and the temperature is held at this temperature for 3 h, and then cooled naturally to room temperature.
S4, product characterization: High-resolution transmission electron microscopy, X-ray diffraction technology, and four-probe conductivity test are used to characterize the morphology, structural characteristics, and conductive characteristics of few-layer coal-based graphene.

The number of layers of the coal-based graphene is less than 10, a degree of graphitization is more than 80%, a purity is more than 80%, and the electrical conductivity is not less than 60000 S/m.

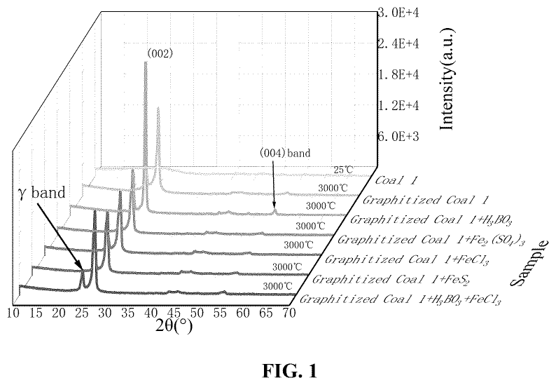

FIG. 1 shows the XRD diffraction patterns of raw coal (Coal 1), graphitized sample (Graphitized Coal 1), graphitized sample catalyzed by boric acid (Graphitized Coal 1+H₃BO₃), graphitized sample catalyzed by iron sulfate (Graphitized Coal 1+Fe₂(SO₄)₃), graphitized sample catalyzed by iron chloride (Graphitized Coal 1+FeCl₃), graphitized sample catalyzed by pyrite (Graphitized Coal 1+FeS₂), and graphitized sample catalyzed by boric acid+iron chloride (Graphitized Coal 1+H₃BO₃+FeCl₃). Among the samples, the graphitized sample combined with boric acid exhibited the strongest (002) peak with the most symmetrical peak shape, indicating the highest graphitization efficiency. This demonstrates that samples graphitized with boric acid as a catalyst achieve superior graphitization, featuring a higher proportion of graphitic structure and minimal or negligible amorphous structure, with no detectable mineral peak shapes.

The lattice parameters of the samples are quantitatively calculated after analyzing the XRD pattern: The aromatic structure layer spacing, the lateral size of the aromatic structure La, the relative content of the graphite structure fa, and the degree of graphitization G of the raw coal, the graphitized sample and the graphitized sample catalyzed by boric acid are calculated by the formula (1), (2), (3), (4). As shown in Table 1, the interlayer spacing of raw coal is larger than that of non-graphite carbon layer by 0.3440 nm, the interlayer spacing of graphitized samples and catalytic graphitized samples is smaller than that of non-graphite carbon layer, and is close to the ideal graphite layer spacing of 0.3354 nm, it shows that the graphitization treatment promotes the evolution of the structure of raw coal to the graphite structure, so that the sample achieves the graphitization, the graphitization degree G is more than 80%, and the graphite structure content is more than 80%. The lateral size La of the aromatic structure of the graphitized sample is enhanced by 12 to 17 times that of the raw coal, and the lateral size of the graphitized sample catalyzed by boric acid is the largest. The maximum fα parameter indicates that the content of the graphite structure in the sample is the most (81.30%), which is the key structural feature to promote the excellent conductivity of the sample.

$${d}_{002} = λ / ( 2 \cdot sin {θ}_{002} ) \qquad ( 1 )$$

$$La = 1.84 \cdot λ / ( {β}_{001} \cdot cos {θ}_{001} ) ; \qquad ( 2 )$$

$$fa = {A}_{002} / ( {A}_{002} + {A}_{γ} ) ; \qquad ( 3 )$$

$$G = 100 \cdot ( 0.344 - {d}_{002} ) / ( 0.344 - 0.3354 ) ; \qquad ( 4 )$$

Where λ is 0.154056 nm, β is the full width at half maximum (FWHM) of the output peak of XRD data processing, A is the peak area, θ is the ½ of the abscissa 2θ of the corresponding peak, 2θ of 002 peak is about 26°, 2θ of 110 peak is about 43°, γ is amorphous carbon, its 2θ is about 22°, which mainly exists in raw coal. All values in formulas (1) to (4) are in radians.

TABLE 1
Aromatic structure parameters of raw coal, graphitized
sample, and graphitized sample catalyzed by boric acid

| Samples | d₀₀₂/nm | La/nm | fa | G(%) |
|---|---|---|---|---|
| Coal 1 | 0.3566 | 2.1703 | 46.11% | — |
| Graphitized Coal 1 | 0.3364 | 24.8343 | 71.48% | 88.29% |
| Graphitized Coal 1 + Boric Acid | 0.3368 | 34.4350 | 81.30% | 84.04% |

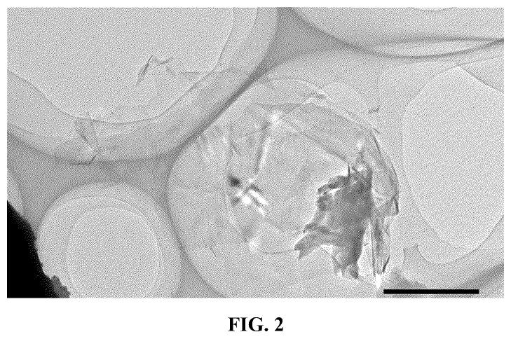

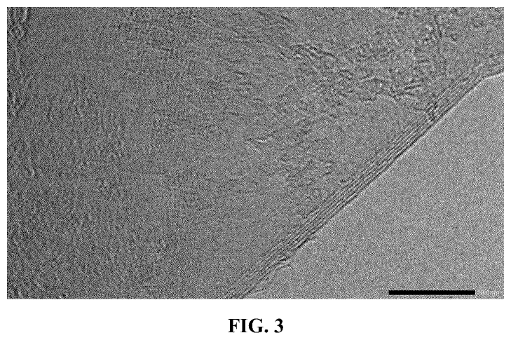

FIG. 2 and FIG. 3 are the HRTEM images of the graphitized sample catalyzed by boric acid, FIG. 2 shows the morphology of the thin-layer graphene (less than 10 layers) in the sample, with a scale bar of 1 μm, the thin-layer graphene in the morphology has strong light transmittance and can clearly see the micro-grid through the thin-layer graphene, and the lateral size of the thin-layer graphene can reach up to 3.5 μm, the large-sized thin-layer graphene shown by HRTEM is the key feature to promote the high conductivity of the sample. FIG. 3 is the enlarged image of thin layer graphene in FIG. 2, the scale bar in FIG. 3 is 10 nm. The lattice fringes shown in the figure are the side view of the graphene layer, the number of graphene layers is 5 layers, fewer than 10 layers. After randomly observing the 50 particles of the graphitized sample under HRTEM and the graphitized sample catalyzed by boric acid, it is found that the volume ratio of graphene with less than 10 layers in the graphitized sample catalyzed by boric acid is larger than that of the graphitized sample.

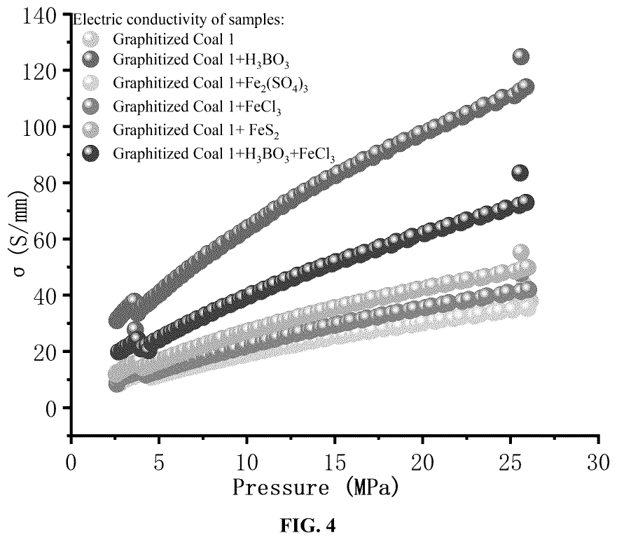

FIG. 4 is graphitized sample (Graphitized Coal 1), graphitized sample+boric acid (Graphitized Coal 1+H₃BO₃), graphitized sample+iron sulfate (Graphitized Coal 1+Fe₂(SO₄)₃), graphitized sample+iron chloride (Graphitized Coal 1+FeCl₃), graphitized sample+pyrite (Graphitized Coal 1+FeS₂), graphitized sample+boric acid+iron chloride (Graphitized Coal 1+H₃BO₃+FeCl₃), the four-probe method of different catalyst comparison test conductivity with pressure change point line diagram, the graphitized sample+boric acid sample conductivity is the strongest.

The four-probe method is used to test the conductivity of the graphitized sample and the graphitized sample catalyzed by boric acid with the pressure change diagram, and the maximum pressure is 25 MPa. The raw coal is not conductive, and the dark blue dots are graphitized sample catalyzed by boric acid, the conductivity increases with the increase of pressure.

Therefore, the present disclosure employs the aforementioned method for preparing catalytic graphitized few-layer coal-based graphene, with high-temperature heat treatment as the basic means, coal as raw material, low-cost and environmentally friendly boric acid as catalyst, fully grinded and uniformly heat-treated at high temperature. Through high-resolution transmission electron microscopy, X-ray diffraction technology, and conductivity test, few-layer coal-based graphene with excellent structure and high conductivity is prepared.

Finally, it should be noted that the above embodiments are only used to explain the technical solutions of the present disclosure rather than to restrict them. Although the present disclosure is described in detail with reference to the preferred embodiments, those of ordinary skill in the art should understand that they can still modify or equivalently substitute the technical solutions of the present disclosure, and these modifications or equivalent substitutions cannot make the modified technical solutions divorce from the spirit and scope of the technical solutions of the present disclosure.

What is claimed is:

1. A method for preparing catalytic graphitized few-layer coal-based graphene, comprising:
S1, raw material pretreatment: comprising crushing coal samples to 200 mesh, then treating with hydrochloric-hydrofluoric acid for deashing, and drying at 25° C. for 12 h to obtain a row coal material;
S2, catalyst mixing: comprising grinding a raw coal and boric acid thoroughly until uniformly mixed, achieving a particle size of 200 mesh, then loading the mixture into a graphite crucible;
S3, high-temperature graphitization: comprising transferring the graphite crucible into a medium-frequency induction graphitization furnace, after evacuating a chamber, introducing protective gas, and raising a temperature to a heat treatment temperature, holding, then cooling naturally to room temperature;
S4, product characterization: comprising using high-resolution transmission electron microscopy, X-ray diffraction, and four-probe conductivity test to characterize morphology, structural characteristics, and conductive characteristics of few-layer coal-based graphene.

2. The method for preparing catalytic graphitized few-layer coal-based graphene according to claim 1, wherein in S1, after the coal samples are deashed, no mineral peak is detected by X-ray diffraction.

3. The method for preparing catalytic graphitized few-layer coal-based graphene according to claim 1, wherein in S2, a purity of boric acid is more than 99.5%, and a mass ratio of raw coal to boric acid is 4:1.

4. The method for preparing catalytic graphitized few-layer coal-based graphene according to claim 1, wherein in S3, a protective atmosphere is argon, an argon flow rate is 3 L/h, a heating rate is 10° C./min, the heat treatment temperature is 3000° C., and a holding time is 3 h.

5. A catalytic graphitized few-layer coal-based graphene, wherein this catalytic graphitized few-layer coal-based graphene is prepared by a preparation method according to claim 1.

6. The catalytic graphitized few-layer coal-based graphene according to claim 5, wherein number of layers of the coal-based graphene is less than 10, a degree of graphitization is more than 80%, a purity is more than 80%, and a electrical conductivity is not less than 60000 S/m.
